(19) United States
(12) Patent Application Publication
(10) Pub. No.: US 2005/0213042 A1
(43) Pub. Date: Sep. 29, 2005

(54) Liquid crystal display device

(75) Inventors: Kazuaki Umemoto, Takefu-city (JP); Takashi Tokuda, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/084,018

(22) Filed: Mar. 21, 2005

(30) Foreign Application Priority Data
Mar. 24, 2004 (JP) 2004-086109

(51) Int. Cl. G03B 21/22

(52) U.S. Cl. 353/18

(57) ABSTRACT

The present invention aims at providing a liquid crystal display device intended to rationalize a layout of various devices provided inside the liquid crystal display device and to reduce dead spaces in the liquid crystal display device, thereby reducing the size and thickness of the device. The liquid crystal display device comprises speakers 10, 10, a recording/reproducing device 11, a liquid crystal display unit 12, and an inverter substrate 13 making up an inverter circuit which controls the liquid crystal display unit 12 within the cabinet of a liquid crystal television receiver 1. The speakers 10, 10 having a smaller height H than the height H1 of the liquid crystal display unit 12 are disposed alongside the liquid crystal display unit 12 and the inverter substrate 13 is disposed in spaces 20 formed above the speakers 10, 10. This allows the inverter substrate 13 to be disposed in the spaces 20 formed because of the height difference (H1−H), making it possible to effectively use the free spaces 20 in the cabinet without dead spaces and provide a smaller and slimmer liquid crystal display device.

The present application is based on and claims priority of Japanese patent application No. 2004-086109 filed on Mar. 24, 2004, the entire contents of which are hereby incorporated by reference.

### BACKGROUND OF THE INVENTION

1. Field of the Invention

The present invention relates to a liquid crystal display device for a liquid crystal television receiver and the like, and more particularly, to a liquid crystal display device designed to reduce the overall size and thickness of the device in consideration of arrangements and structures of various substrates and a recording/reproducing device and the like provided for the liquid crystal display device.

2. Description of the Related Art

Compared to a conventional display device using a so-called cathode ray tube, a liquid crystal display device used in recent years is more compact and lighter, matching customer needs, and is therefore becoming widespread at an increasingly rapid pace.

FIG. 5 is a cross-sectional view of a conventional liquid crystal television receiver 101 whose outer shape is formed of a front cabinet 102 and a rear cabinet 103 integrated into a single unit viewed from above. Since various circuit substrates 113 and a recording/reproducing device 111 are provided in the conventional liquid crystal television receiver 101 shown in FIG. 5, these components are arranged according to a complicated layout. In the cross direction (vertical direction in FIG. 5) of the liquid crystal television receiver 101, devices such as the liquid crystal display unit 112, the circuit substrate 113, and the recording/reproducing device 111 are disposed in such a way as to overlap with one another in the cross direction. A conventional technology on such a liquid crystal television receiver provided with a recording/reproducing device is disclosed in Japanese Patent Laid-Open Publication No. H05-053099 (Patent Document 1) and the like.

In the above described related art, since three or more devices such as the liquid crystal display unit, the circuit substrate, and the recording/reproducing device are disposed in such a way as to overlap with one another in the cross direction of the liquid crystal television receiver, the thickness in the cross direction of the liquid crystal display device which is the liquid crystal television receiver increases, which makes it difficult to create a slimmer and smaller liquid crystal television receiver.

### SUMMARY OF THE INVENTION

The present invention has been implemented in view of the above described problems and it aims at providing a liquid crystal display device with a rationalized layout of various devices provided inside the liquid crystal display device, and also providing a reduced dead space inside the liquid crystal display device which is designed to reduce the size and thickness.

The liquid crystal display device according to the first aspect of the invention is a liquid crystal display device comprising in a cabinet a speaker, a recording/reproducing device, a liquid crystal display unit, and an inverter substrate making up an inverter circuit which controls the liquid crystal display unit, wherein the speaker having a smaller height than the height of the liquid crystal display unit is disposed alongside the liquid crystal display unit and the inverter substrate is disposed in a space formed above the speaker in the cabinet.

According to the first aspect of the invention, the speaker having a smaller height than the height of the liquid crystal display unit is disposed, which allows the inverter substrate to be disposed in the space formed above the speaker due to a difference in height. Therefore, by disposing the inverter circuit in such a space, it is possible to effectively utilize the space formed in the cabinet without dead spaces. Furthermore, disposing the inverter substrate in the space alongside the liquid crystal display unit eliminates the necessity to arrange this inverter substrate, the liquid crystal display unit, and the recording/reproducing device in such a way as to overlap with one another in the cross direction of the liquid crystal display device as in the case of the conventional liquid crystal display device, which makes it possible to reduce the thickness of the cabinet.

The liquid crystal display device according to the second aspect of the invention is the liquid crystal display device according to the first aspect of the invention, wherein the space in the cabinet formed above the speaker is replaced by a space in the cabinet formed below the speaker.

According to the arrangement of the second aspect of the invention, the speaker having a smaller height than the height of the liquid crystal display unit is disposed, which allows the inverter substrate to be disposed in the space formed below the speaker due to a difference in height. Therefore, disposing the inverter circuit in such a space makes it possible to effectively utilize the space formed in the cabinet without dead spaces.

The liquid crystal display device according to the third aspect of the invention is the liquid crystal display device according to the first or the second aspect of the invention, wherein the recording/reproducing device is provided on the back of the liquid crystal unit and the recording/reproducing device is disposed at a position facing the space in which the inverter substrate is disposed.

According to the arrangement of the third aspect of the invention, the recording/reproducing device is provided on the back of the liquid crystal panel, and therefore it is possible to eliminate dead spaces between the recording/reproducing device and the liquid crystal display unit and reduce the depth of the cabinet and thereby make the liquid crystal display device smaller and slimmer. Furthermore, since the recording/reproducing device is disposed so as to face the space, it is possible to effectively dissipate heat produced when a recording medium is being recorded or reproduced by the recording/reproducing device from the space.

The liquid crystal display device according to the fourth aspect of the invention is the liquid crystal display device according to any one of the first to the third aspects of the invention, wherein the speaker is provided inside the cabinet and a pair of such speakers are arranged on the right and left sides of the liquid crystal display unit.

According to the arrangement of the fourth aspect of the invention, since a pair of speakers are arranged on the right and left sides of the liquid crystal display unit, it is possible to allow different sounds to be output from the right and left speakers and thus obtain sounds output with an enhanced sense of realism instead of outputting sounds from a single unit. Furthermore, spaces are formed above or below both speakers, and therefore it is possible to dispose the inverter circuit in one space and dispose various substrates and devices in the other space as required, which-provides excellent expandability.

The liquid crystal display device according to the fifth aspect of the invention is the liquid crystal display device according to any one of the first to the fourth aspect of the invention, wherein the cabinet is made up of a front cabinet and a back cabinet, which are detachable forward and backward and the liquid crystal display unit and the recording/reproducing device are provided on the front cabinet side.

According to the arrangement of the fifth aspect of the invention, the liquid crystal display unit and the recording/reproducing device are relatively heavy among various devices making up the liquid crystal display device. With such heavy liquid crystal display unit and recording/reproducing device attached to the front cabinet which is one of the two detachable cabinets, it is possible to attach an independent back cabinet without any heavy device as opposed to such a front cabinet, which facilitates attaching of the back cabinet to the front cabinet and provides excellent operability.

The liquid crystal display device according to the first aspect of the invention is a liquid crystal display device comprising in a cabinet a speaker, a recording/reproducing device, a liquid crystal display unit, and an inverter substrate making up an inverter circuit which controls the liquid crystal display unit, wherein the speaker having a smaller height than the height of the liquid crystal display unit is disposed alongside the liquid crystal display unit and the inverter substrate is disposed in a space formed above the speaker in the cabinet, and therefore it is possible to dispose the inverter substrate in the space, effectively utilize the free space formed in the cabinet without dead spaces. Furthermore, by disposing the inverter substrate in the space alongside the liquid crystal display unit, it is possible to make the cabinet more compact and slimmer. Thus, it is possible to provide a smaller and slimmer liquid crystal display device.

The liquid crystal display device according to the second aspect of the invention is the liquid crystal display device according to the first aspect of the invention, wherein the space in the cabinet formed above the speaker is replaced by a space in the cabinet formed below the speaker, and therefore it is possible to dispose the inverter substrate in the space in the cabinet and effectively utilize the free space formed in the cabinet without dead spaces. Furthermore, the arrangement of the inverter substrate in the space alongside the liquid crystal display unit makes it possible to slim the cabinet and thereby provide a smaller and slimmer liquid crystal display device.

The liquid crystal display device according to the third aspect of the invention is the liquid crystal display device according to the first or the second aspect of the invention, wherein the recording/reproducing device is provided on the back of the liquid crystal unit and the recording/reproducing device is disposed at a position facing the space in which the inverter substrate is disposed, and therefore it is possible to eliminate dead spaces between the recording/reproducing device and the liquid crystal display unit and reduce the depth of the cabinet and thereby make the liquid crystal display device smaller and slimmer. Furthermore, since the recording/reproducing device is disposed so as to face the space, it is possible to effectively dissipate heat produced when a recording medium is being recorded or reproduced by the recording/reproducing device from the space, thus providing an excellent heat radiation characteristic and avoiding the possibility of provoking a malfunction of the liquid crystal display device.

The liquid crystal display device according to the fourth aspect of the invention is the liquid crystal display device according to any one of the first to the third aspects of the invention, wherein the speaker is provided inside the cabinet and a pair of such speakers are arranged on the right and left sides of the liquid crystal display unit, and therefore it is possible to allow different sounds to be output from the right and left speakers and thus obtain sounds output with an enhanced sense of realism instead of outputting sounds from a single unit. Furthermore, spaces are formed above or below both speakers, and therefore it is possible to dispose the inverter circuit in one space and dispose various substrates and devices in the other space as required, which provides excellent expandability.

The liquid crystal display device according to the fifth aspect of the invention is the liquid crystal display device according to any one of the first to the fourth aspect of the invention, wherein the cabinet is made up of a front cabinet and a back cabinet, which are detachable forward and backward and the liquid crystal display unit and the recording/reproducing device are provided on the front cabinet side, and therefore it is possible to attach an independent back cabinet to the front cabinet provided with the heavy liquid crystal display unit and recording/reproducing device, which facilitates attaching of the back cabinet to the front cabinet, providing excellent operability and improving productivity.

### BRIEF DESCRIPTION OF THE DRAWINGS

FIG. 1 is a front view of a liquid crystal television receiver according to the present embodiment;

FIG. 2 is a rear view of a front cabinet of the liquid crystal television receiver with a back cabinet removed according to the present embodiment;

FIG. 3 is a rear view of the front cabinet with a partially cutaway view of the recording/reproducing device according to the present embodiment;

FIG. 4 is an enlarged cross-sectional view of main components of the liquid crystal television receiver viewed from above according to the present embodiment; and

FIG. 5 is an enlarged cross-sectional view of main components of a liquid crystal television receiver viewed from above used in a conventional embodiment.

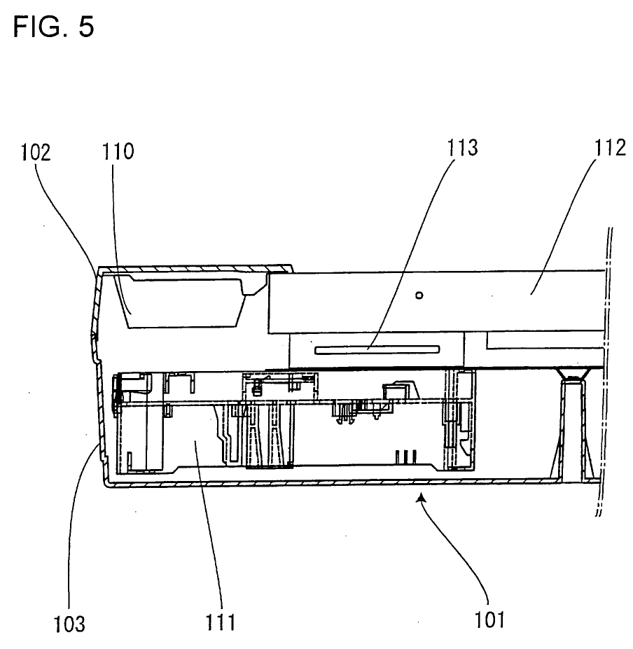

### DETAILED DESCRIPTION OF THE PREFERRED EMBODIMENTS

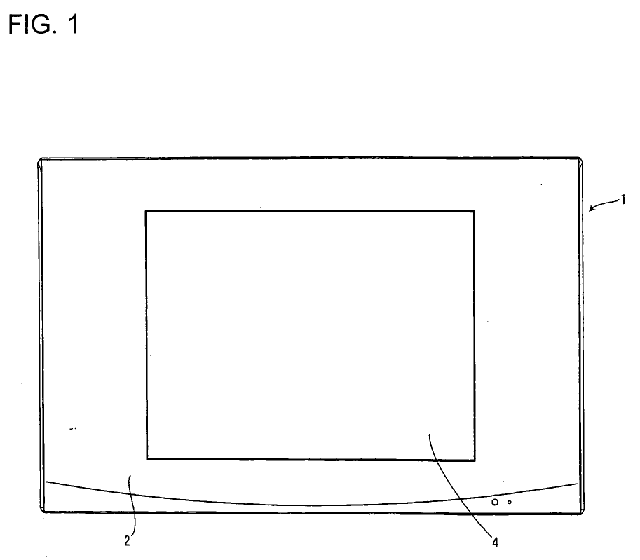

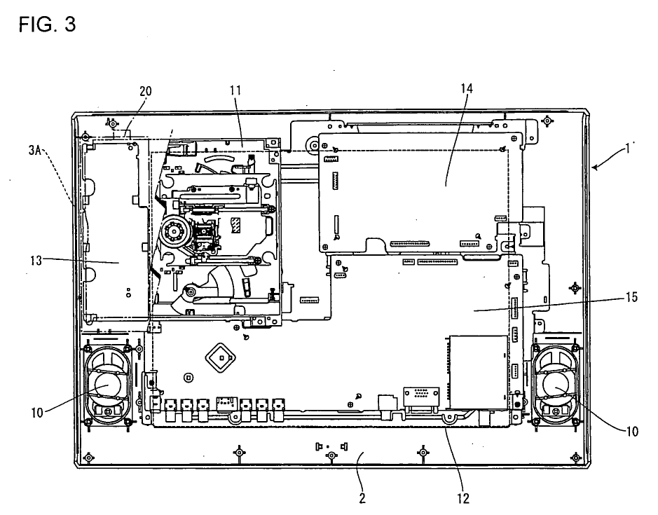

With reference now to FIGS. 1 to 4, a preferred embodiment of the present invention for implementing the present invention will be explained below. Please note that the present invention is also easily applicable to any arrangements other than that explained in the embodiment within the scopes of the present invention.

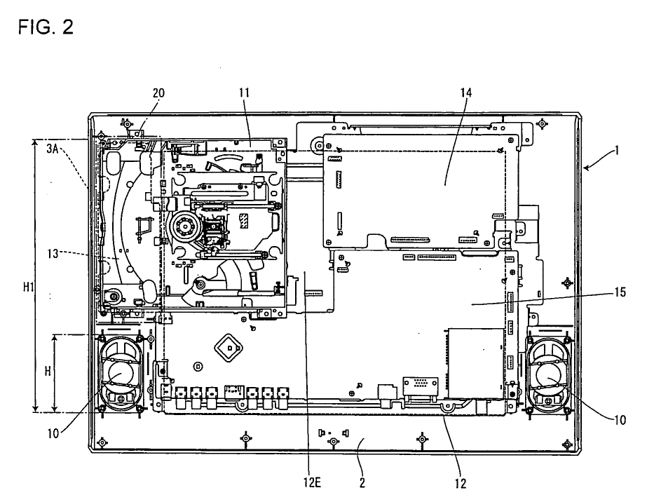

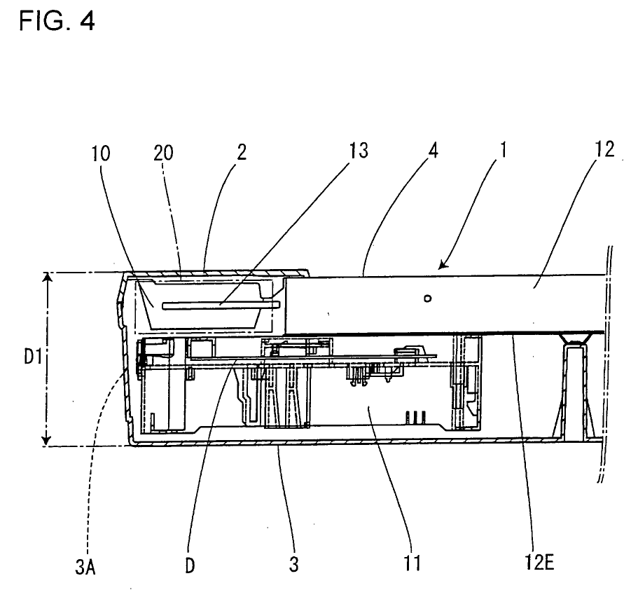

FIG. 1 is a front view of a liquid crystal television receiver according to the embodiment and FIG. 2 is a rear view of the liquid crystal television receiver with a back cabinet removed according to the embodiment. The television receiver 1 which is a liquid crystal display device has an outline formed of a cabinet made of synthetic resin and the entire cabinet is formed in a thin box shape in the cross direction (vertical direction in FIG. 4) and is made up of a front cabinet 2 and a back cabinet 3 which are detachable forward and backward. Furthermore, a display window 4, which will be explained later, is provided in the center on the front side of the front cabinet 2 and video are displayed in this display window 4.

Furthermore, as shown in FIG. 2, there are main components in the cabinet made up of the front cabinet 2 and the back cabinet 3 such as a pair of speakers 10, 10, a recording/reproducing device 11, a liquid crystal display unit 12, an inverter substrate 13, an MPEG substrate 14 which realizes the function of compressing or expanding moving video and audio in real time, and an LCD (liquid crystal display) substrate 15. Note that these main components are attached to the front cabinet 2 instead of the back cabinet 3. “Being attached to the front cabinet 2” means that when the front cabinet 2 is separated from the cabinet 3, the aforementioned main components are attached to the front cabinet 2.

Here, the functions and the like of the main components will be explained. The recording/reproducing device 11 can rotate, load/unload a pickup to read a signal from an optical disk D such as a DVD (digital video disk) and the optical disk D, and move a pickup lens built in the recording/reproducing device 11 to record/reproduce or perform any one of these operations. This recording/reproducing device 11 allows the operator of the liquid crystal television receiver 1 to load/unload the optical disk D into/from the recording/reproducing device 11 through a loading/unloading opening 3A, which is an opening formed in the back cabinet 3.

Furthermore, the liquid crystal display unit 12 consists of a liquid crystal panel, a circuit which drives this liquid crystal panel, and a backlight which are integrated into one unit. Furthermore, the liquid crystal display unit 12 is electrically connected to an LCD substrate 15 through wiring (not shown) and the like, and the liquid crystal display unit 12 and LCD substrate 15 are intended to input/output a digital RGB signal which is an video signal to display an video on the liquid crystal panel of the liquid crystal display unit 12 and a control signal to drive the liquid crystal display unit 12 normally.

The inverter substrate 13 forms an inverter circuit to cause the liquid crystal display unit 12 to light on a backlight and the input side of the inverter substrate 13 is supplied with DC power and ON/OFF control signal from the LCD substrate 15. On the other hand, the output side of the inverter substrate 13 is connected to the backlight of the liquid crystal display unit 12 through an AC power supply. As described above, the inverter substrate 13 constitutes an inverter circuit and controls ON/OFF of the backlight which is integral with the liquid crystal display unit 12 or controls adjustments of brightness of the backlight.

Furthermore, the MPEG substrate 14 is provided with a circuit which converts a digital signal read from the optical disk D inserted in the recording/reproducing device 11 to an analog video signal and audio signal and a circuit which controls the recording/reproducing device 11, and the MPEG substrate 14 in this embodiment can convert a digital signal which is data compressed according to a predetermined system such as an MPEG system, recorded in the optical disk D inserted in the recording/reproducing device 11 to an video signal and audio signal prior to the compression.

Furthermore, the LCD substrate 15 is provided with a circuit which converts an analog video signal to a digital signal and a circuit which controls displays of video on the liquid crystal display unit 12, and is also provided, though not shown, with a tuner which receives radio waves of telecasting or external input terminal, external output terminal, and AC input terminal and the like, as appropriate.

Next, the arrangement and structure of the liquid crystal television receiver 1 according to the above described main structure in the cabinet will be explained.

As described above, the outline of the cabinet consists of the front cabinet 2 and back cabinet 3 and is formed in a box shape whose thickness in the cross direction is small. The thin box type liquid crystal display unit 12 is attached to the front cabinet 2 in the center on the front side (top in FIG. 4) of the front cabinet 2 using screws and the like. Furthermore, a pair of speakers 10, 10 are fixed to the front cabinet 2 on the right and left sides of this liquid crystal display unit 12 using screws and the liquid crystal display unit 12 having a rectangular display window 4 is provided in the center on the front of the front cabinet 2 and video are displayed on the display window 4 of the liquid crystal display unit 12 as described above.

Furthermore, the speakers 10, 10 are formed substantially into the same shape and the height H of these speakers 10, 10 is formed to be smaller than the height H1 of the liquid crystal display unit 12 and the bottom ends of the liquid crystal display unit 12 and speakers 10, 10 are substantially aligned to thereby form spaces 20 above the respective speakers 10, 10 in the cabinet, and as shown in FIG. 4 in this embodiment, the inverter substrate 13 is disposed in any one of these spaces 20 and this inverter substrate 20 is fixed to the front cabinet 2 with screws. In this embodiment, these spaces 20, 20 are formed above the speakers 10, 10, but the spaces 20 may also be formed below the speakers 10, 10 by disposing these speakers 10, 10 at the top and the arrangement of the speakers 10, 10 is not particularly limited to the above described positions.

Furthermore, the recording/reproducing device 11 is formed into a box shape as a whole and attached to the back 12E of the liquid crystal display unit 12 in contact therewith using screws and the like. In this case, not the entire surface of either side of the recording/reproducing device 11 is attached to the liquid crystal display unit 12 in contact therewith, but as shown in FIG. 4, the recording/reproducing device 11 is attached to the liquid crystal display unit 12 in such a way that one portion of the recording/reproducing device 11 faces the above described space 20, allowing the optical disk D to be loaded or unloaded into/from the recording/reproducing device 11 through a loading/unloading opening 3A formed on one side of the liquid crystal television receiver 1. In this way, by disposing the recording/reproducing device 11 on one side of the liquid crystal television receiver 1, the operator who operates the liquid crystal television receiver 1 can load or unload the optical disk D into/from the recording/reproducing device 11 through the loading/unloading opening 3A with an video being displayed in the display window 4 of the liquid crystal display unit 12, which provides excellent operability.

Furthermore, the flat MPEG substrate 14 and the LCD substrate 15 are attached to the back 12E of the liquid crystal display unit 12 using screws, with one side of the MPEG substrate 14 and LCD substrate 15 facing the back 12E of the liquid crystal display unit 12 and arranged at a certain distance from the back 12E of the liquid crystal display unit 12.

Thus, the liquid crystal television receiver 1 according to this embodiment arranges in the cabinet the main components such as speakers 10, 10, recording/reproducing device 11, liquid crystal display unit 12, inverter substrate 13, MPEG substrate 14 which realizes the function of compression/expansion of moving video and audio in real time, and LCD substrate 15 in such a way that not more than three of these components overlap with one another in the cross direction (vertical direction in FIG. 4) of the liquid crystal television receiver 1, that is, at maximum two such components overlap with each other at any given position in the cabinet, and therefore it is possible to make the dimension D1 in the cross direction of the cabinet made up of the front cabinet 2 and back cabinet 3 as small as possible. Thus, it is possible to reduce the depth D1 (vertical direction in FIG. 4) of the liquid crystal television receiver 1 having the same dimension and provide the liquid crystal television receiver 1 which is slimmer and more compact than the conventional liquid crystal television receiver.

As shown above, the liquid crystal television receiver 1 which is the liquid crystal display device according to this embodiment comprises the speaker 10, 10, recording/reproducing device 11, liquid crystal display unit 12, and the inverter substrate 13 which constitutes the inverter circuit for controlling the liquid crystal display unit 12 in the cabinet made up of the front cabinet 2 and the back cabinet 3, disposes the speakers 10, 10 having the smaller height H than the height H1 of the liquid crystal display unit 12 alongside this liquid crystal display unit 12, and can thereby dispose the inverter substrate 13 in the spaces 20, 20 formed above the speakers 10, 10 in the cabinet because of the height difference (H1−H). Therefore, it is possible to dispose the inverter substrate 13 in such a space 20 and effectively use the free space 20 in the cabinet without dead spaces. Furthermore, by disposing the inverter substrate 13 in the space 20 at one side of the liquid crystal display unit 12, it is possible to prevent the inverter substrate, liquid crystal display unit, and recording/reproducing device from overlapping with one another in the cross direction of the liquid crystal television receiver as in the case of the conventional liquid crystal display device and thereby reduce the size and thickness of the cabinet made up of the front cabinet 2 and the back cabinet 3 of the liquid crystal television receiver 1. Thus, it is possible to provide a smaller and slimmer liquid crystal television receiver 1. Furthermore, as another embodiment, the speakers 10, 10 are disposed at the top of the liquid crystal television receiver 1 inside the cabinet instead of the spaces 20, 20 in the cabinet formed above the speakers 10, 10, and when the spaces 20, 20 are formed below the speakers 10, 10, as in the case where the spaces are formed above the speakers 10, 10, the speakers 10, 10 having a smaller height H than the height H1 of the liquid crystal display unit 12 are disposed, and therefore it is possible to dispose the inverter substrate 13 in the spaces 20, 20 formed below the speakers 10, 10 because of the height difference (H1−H). Therefore, it is possible to dispose the inverter substrate 13 in such a space 20 and thereby effectively use the free space 20 in the cabinet without dead spaces and by disposing the inverter substrate 13 in the space 20 alongside the liquid crystal display unit 12, it is possible to reduce the thickness of the cabinet of the liquid crystal television receiver 1 and thereby provide a smaller and slimmer liquid crystal television receiver 1. Furthermore, by attaching the recording/reproducing device 11 to the back 12E of the liquid crystal display unit 12 and disposing the recording/reproducing device 11 at a position facing the space 20 in which the inverter substrate 13 is disposed, the recording/reproducing device 11 is provided on the back 12E of the liquid crystal display unit 12, which eliminates dead spaces between the recording/reproducing device 11 and the liquid crystal display unit 12 and can reduce the depth of the cabinet, that is, the depth D of the liquid crystal television receiver 1 makes it possible to make the liquid crystal television receiver 1 smaller and slimmer. Furthermore, since the recording/reproducing device 11 is disposed facing any one of the spaces 20, it is possible to effectively dissipate heat produced while the recording/reproducing device 11 is recording/reproducing data on/from a recording medium such as an optical disk D from the space and thereby provide an excellent heat radiating characteristic and avoid malfunctions of the liquid crystal television receiver 1 due to heat. Moreover, the speakers 10, 10 are provided inside the cabinet and disposed at the right and left sides of the liquid crystal display unit 12 as a pair, and therefore it is possible to output different sounds from the right and left speakers 10, 10 and obtain sounds with a sense of realism instead of outputting sounds with a single system. Furthermore, since the spaces 20, 20 are formed above or below any one of the speakers 10, 10, it is possible to dispose the inverter substrate 13 in one space 20 and also dispose various substrates and devices in the other space 20 as appropriate, providing excellent expandability. Furthermore, the cabinet is made up of the front cabinet 2 and back cabinet 3 which are detachable forward and backward and the liquid crystal display unit 12 and the recording/reproducing device 11 are attached to the front cabinet 2. In such an arrangement, the liquid crystal display unit 12 and the recording/reproducing device 11 are relatively heavy among the various devices making up the liquid crystal television receiver 1. With such heavy liquid crystal display unit 12 and recording/reproducing device 11 attached to the front cabinet 2 which is one of the two detachable cabinets, it is possible to attach the independent back cabinet 3 with no heavy device attached thereto to the front cabinet 2 and thereby facilitate the attaching of the back cabinet 3 to the front cabinet 2, providing excellent operability and improving productivity.

One preferred embodiment of the present invention has been described in detail as above, however, the present invention is not limited to this embodiment and can be implemented modified in various ways within the scopes of the present invention. For example, the above described embodiment has illustrated an example where the invention is applied to the liquid crystal television receiver 1, however, the present invention is not limited to the liquid crystal television receiver 1 and is widely applicable to various liquid crystal display devices such as a notebook or desktop type personal computer or portable information terminal and the like. Furthermore, the recording/reproducing device 11 is used in this embodiment for recording/reproducing on an optical disk such as a DVD, however, it can be substituted by using a hard disk drive and the like instead, not particularly limited to the recording/reproducing device 11. Furthermore, the recording/reproducing device 11 is capable of both recording and reproducing functions, however, the recording/reproducing device 11 is not limited to those functions and the recording/reproducing device 11 can have any one of these functions. Moreover, the various substrates in this embodiment are mounted with various electronic parts and the like, however, these parts do not constitute the essence of the present invention, and therefore their illustrations in the drawings are omitted.

1. A liquid crystal display device comprising in a cabinet a speaker, a recording/reproducing device, a liquid crystal display unit, and an inverter substrate making up an inverter circuit which controls the liquid crystal display unit, wherein the speaker having a smaller height than the height of the liquid crystal display unit is disposed alongside the liquid crystal display unit and the inverter substrate is disposed in a space formed above the speaker in the cabinet.

2. The liquid crystal display device according to claim 1, wherein the space in the cabinet formed above the speaker is replaced by a space in the cabinet formed below the speaker.

3. The liquid crystal display device according to claim 1, wherein the recording/reproducing device is provided on the back of the liquid crystal unit and the recording/reproducing device is disposed at a position facing the space in which the inverter substrate is disposed.

4. The liquid crystal display device according to claim 1, wherein the speaker is provided inside the cabinet and a pair of such speakers are arranged on the right and left sides of the liquid crystal display unit.

5. The liquid crystal display device according to claim 1, wherein the cabinet is made up of a front cabinet and a back cabinet, which are detachable forward and backward and the liquid crystal display unit and the recording/reproducing device are provided on the front cabinet side.

6. The liquid crystal display device according to claim 2, wherein the recording/reproducing device is provided on the back of the liquid crystal unit and the recording/reproducing device is disposed at a position facing the space in which the inverter substrate is disposed.

7. The liquid crystal display device according to claim 2, wherein the speaker is provided inside the cabinet and a pair of such speakers are arranged on the right and left sides of the liquid crystal display unit.

8. The liquid crystal display device according to claim 3, wherein the speaker is provided inside the cabinet and a pair of such speakers are arranged on the right and left sides of the liquid crystal display unit.

9. The liquid crystal display device according to claim 6, wherein the speaker is provided inside the cabinet and a pair of such speakers are arranged on the right and left sides of the liquid crystal display unit.

10. The liquid crystal display device according to claim 2, wherein the cabinet is made up of a front cabinet and a back cabinet, which are detachable forward and backward and the liquid crystal display unit and the recording/reproducing device are provided on the front cabinet side.

11. The liquid crystal display device according to claim 3, wherein the cabinet is made up of a front cabinet and a back cabinet, which are detachable forward and backward and the liquid crystal display unit and the recording/reproducing device are provided on the front cabinet side.

12. The liquid crystal display device according to claim 4, wherein the cabinet is made up of a front cabinet and a back cabinet, which are detachable forward and backward and the liquid crystal display unit and the recording/reproducing device are provided on the front cabinet side.

13. The liquid crystal display device according to claim 6, wherein the cabinet is made up of a front cabinet and a back cabinet, which are detachable forward and backward and the liquid crystal display unit and the recording/reproducing device are provided on the front cabinet side.

14. The liquid crystal display device according to claim 7, wherein the cabinet is made up of a front cabinet and a back cabinet, which are detachable forward and backward and the liquid crystal display unit and the recording/reproducing device are provided on the front cabinet side.

15. The liquid crystal display device according to claim 8, wherein the cabinet is made up of a front cabinet and a back cabinet, which are detachable forward and backward and the liquid crystal display unit and the recording/reproducing device are provided on the front cabinet side.

16. The liquid crystal display device according to claim 9, wherein the cabinet is made up of a front cabinet and a back cabinet, which are detachable forward and backward and the liquid crystal display unit and the recording/reproducing device are provided on the front cabinet side.
